(19) United States
(12) Patent Application Publication
(10) Pub. No.: US 2009/0286044 A1
(43) Pub. Date: Nov. 19, 2009

(54) Composite Wood Products and Methods for Manufacturing the Same

(76) Inventor: William H. Crostic, JR., Simpsonville, SC (US)

Correspondence Address: DORITY & MANNING, P.A., POST OFFICE BOX 1449, GREENVILLE, SC, 29602-1449, US

(21) Appl. No.: 12/120,447

(22) Filed: May 14, 2008

(51) Int. Cl. B32B 23/04; B29C 70/00; B32B 23/02

(52) U.S. Cl. 428/151; 264/241

(57) ABSTRACT

In accordance with one embodiment of the present disclosure a composite wood product is provided. The composite wood product has a composite wood base, the base including about 35 weight percent to about 55 weight percent fiber material and about 35 weight percent to about 55 weight percent thermoplastic resin. A surface layer is laminated on at least a portion of the base, the surface layer having a thickness of about 0.01 millimeters to about 0.5 millimeters, the surface layer including about 0.5 weight percent to about 10 weight percent pigment and about 45 weight percent to about 75 weight percent polyolefin or copolymer thereof.

### BACKGROUND

Wood composites are increasingly being utilized as a replacement material for traditional solid wood products. Wood composites generally contain wood and thermoplastic polymers. Such composites are formed for use in many of the same applications as a solid wood product while offering advantages such as high resistance to insect penetration and moisture damage.

Conventional wood composites include various additives to add color and protect against mildew, ultraviolet light exposure, discoloration or the like. However, additives can be very expensive, particularly when they are incorporated throughout the entire wood composite. In an effort to decrease the usage of such materials, multi-layer wood composite products have been utilized. Multi-layer wood composite products can include a substrate layer with a cap layer disposed on at least one surface of the substrate layer. By limiting the additives to the cap layer, costs can be reduced while still providing the desired protection. However, conventional methods of forming multi-layer wood composite products are still lacking with respect to efficiency and cost savings.

For example, multi-layer products are often formed utilizing co-extrusion methods in which extrudates are extruded through separate orifices of a single die and merged to form multiple layers. Unfortunately, such co-extrusion methods are very costly and can still result in excess material being utilized for the cap layer(s).

Thus, a need exists for methods of forming composite products that are efficient and cost-effective. Composite wood products formed by utilizing such methods would be particularly beneficial.

### SUMMARY

Objects and advantages of the invention will be set forth in part in the following description, or may be obvious from the description, or may be learned through practice of the invention.

In accordance with one embodiment of the present disclosure a composite wood product is provided. The composite wood product has a composite wood base, the base including about 35 weight percent to about 55 weight percent fiber material and about 35 weight percent to about 55 weight percent thermoplastic resin. A surface layer is laminated on at least a portion of the base, the surface layer having a thickness of about 0.01 millimeters to about 0.5 millimeters, the surface layer including about 0.5 weight percent to about 10 weight percent pigment and about 45 weight percent to about 75 weight percent polyolefin or copolymer thereof.

In another embodiment of the present disclosure a method for making a composite wood product is provided. The method includes extruding a mass having fiber material and thermoplastic resin to form a composite wood base, the base including about 35 weight percent to about 55 weight percent fiber material and about 35 weight percent to about 55 weight percent thermoplastic resin. A surface material is laminated on at least a portion of the base to form a surface layer, the surface layer having a thickness of about 0.01 millimeters to about 0.5 millimeters, the surface layer including about 0.5 weight percent to about 10 weight percent pigment and about 45 weight percent to about 75 weight percent polyolefin or copolymer thereof.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figure in which:

FIG. 1 is a perspective view of a composite wood board in accordance with certain embodiments of the present disclosure; and

FIG. 2 is a schematic view of a system that can be used in accordance with certain embodiments of the present disclosure.

Repeat use of reference characters in the present specification and drawings is intended to represent same or analogous features or elements of the disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure is generally directed to methods for making a composite wood product. The methods include providing a mass having fiber material and thermoplastic resin, extruding the mass to form a composite wood base, and laminating a surface material on at least a portion of the base to form a surface layer, the surface layer having a thickness of from about 0.01 millimeters to about 0.5 millimeters.

Additionally, the present disclosure describes a composite wood product having a composite wood base formed from fiber material and thermoplastic resin. A surface layer is laminated on at least a portion of the base with the surface layer having a thickness of from about 0.01 millimeters to about 0.5 millimeters.

The methods described herein do not require the use of expensive and inefficient co-extrusion processes. Rather, the present methods allow for a very thin surface layer to be laminated onto the surface of a composite wood base thereby decreasing the costs required for expensive additives. Such a process can significantly decrease the amount of additives required to form a composite wood product. For instance, the methods of the present disclosure can be utilized to form a wood base without any pigments being utilized. Rather, the pigments can be added to the surface layer which is laminated onto the surface of the composite wood base providing an aesthetically pleasing appearance to the composite wood product while reducing the amount of pigment necessary. In this manner, the present methods are more cost-effective and efficient than conventional methods.

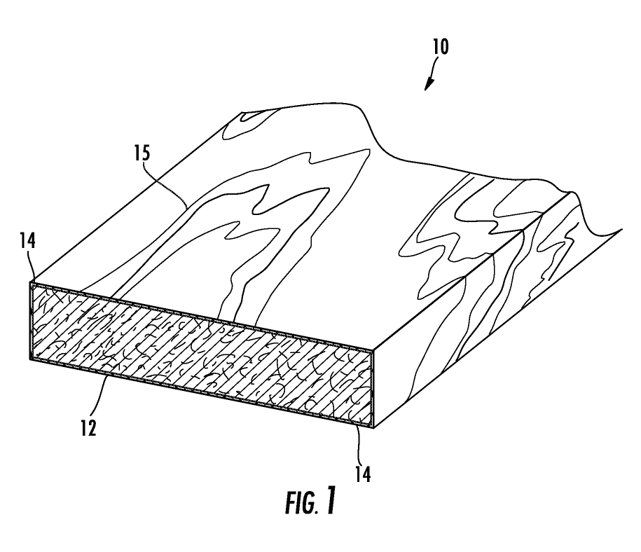

Referring to FIG. 1, a composite wood product in accordance with one embodiment of the present disclosure is illustrated. The composite wood product is particularly contemplated for use in decking applications, as illustrated by the composite wood product 10 of FIG. 1. However, the products described herein are equally suitable for other applications, including, but not limited to, siding, floor tiles, paneling, moldings, steps, door and window sills and sashes, outdoor furniture, fencing, playground equipment, posts and barn components, and marine items such as decking, bulkheads and pilings, and the like. In this regard, the composite wood product can have suitable dimensions as would be known in the art. For example, for decking applications, the composite wood product can be formed to standard sizes, such as from about 2 inches thickness by 4 inches width and any suitable length.

The composite wood product 10 includes a base 12 that generally contains about 35 weight percent to about 55 weight percent fiber material, more particularly from about 40 weight percent to about 50 weight percent fiber material, and still more particularly from about 45 weight percent to about 50 weight percent fiber material. In this regard, fiber material can include wood fiber, glass fiber, cotton fiber, carbon fiber, graphite fiber, and combinations thereof. Preferably, the fibers can be cellulosic and derived from recycled paper products, such as agrifibers, pulp, newsprint, soft woods, such as pine, or hard woods from deciduous trees. Hard woods are generally preferred for fiber manufacture because they absorb less moisture, can cost less than other wood types, and can contribute more structural value to the composite wood product. In embodiments in which hard wood is utilized as the primary source of fiber, additional fiber make-up can be derived from secondary sources including soft wood fibers, natural fibers including bamboo, rice, sugar cane, and recycled or reclaimed fiber from newspapers, cardboard boxes, or the like, and combinations thereof.

The base 12 also generally contains about 35 weight percent to about 55 weight percent thermoplastic resin, more particularly from about 40 weight percent to about 50 weight percent thermoplastic resin, and still more particularly from about 45 weight percent to about 50 weight percent thermoplastic resin. Preferably, the thermoplastic resin can include a polyolefin or copolymer thereof, such as polypropylene, and may be entirely polypropylene. However, other suitable thermoplastic resins can be utilized in combination with or separately from polypropylene. For example, polyvinyl chloride, polyethylene, nylon, polyesters, polysulfones, polyphenylene oxide and sulphide, epoxies, cellulosics, and combinations thereof are also suitable thermoplastic resins that can be used in connection with the present disclosure.

In certain embodiments, the base 12 can also include one or more additional additives. For example, coupling agents, impact modifiers, thermal stabilizers, reinforcing agents, lubricants, plasticizers, organic and inorganic pigments, UV stabilizers, filler material, biocides, processing aids, flame retardants, and combinations thereof can all be utilized in connection with the present disclosure. Such additives can be individually present in an amount from about 0.5 weight percent to about 5 weight percent.

The thickness of the base 12 can vary depending on the particular application of the composite wood product. In certain embodiments, the base 12 can have a thickness of about 10 millimeters to about 60 millimeters, particularly from about 20 millimeters to about 55 millimeters thickness, more particularly, about 25 millimeters thickness. The thicknesses can vary as would be understood by one skilled in the art depending upon application for the composite wood product.

In addition, the composite wood product 10 includes a surface layer 14. The surface layer 14 generally contains about 45 weight percent to about 75 weight percent thermoplastic resin, more particularly from about 60 weight percent to about 70 weight percent thermoplastic resin, and still more particularly from about 65 weight percent to about 70 weight percent thermoplastic resin. Again, preferably the thermoplastic resin includes a polyolefin or copolymer thereof, such as polypropylene (and may be entirely polypropylene) but any suitable thermoplastic resin as described herein is contemplated by the present disclosure.

The surface layer 14 further includes one or more pigments. The pigment is present in the surface layer 14 in an amount of about 0.5 weight percent to about 15 weight percent, particularly from about 1 weight percent to about 10 weight percent, more particularly from about 1 weight percent to about 3 weight percent. In this regard, suitable pigments can include organic and inorganic pigments as would be known in the art. It has been determined that the surface layer 14 can beneficially provide color to the composite wood product 10 utilizing a fraction of the pigment that would be required in conventional products. The surface layer 14 can serve to cover the composite wood base 12, thereby minimizing the amount of pigment required in the composite wood base 12. For instance, suitable pigments can include color-fast and/or UV stable pigments such as iron oxide based pigments. In certain embodiments, an IR-reflective pigment can be utilized to reduce the heat build-up from sunlight in decking applications.

In certain embodiments, the surface layer 14 can also include one or more additional additives. For example, UV stabilizers, filler material, biocides, processing aids, flame retardants, and combinations thereof can all be utilized in connection with the surface layer 14. Such additives can be individually present in an amount from about 1 weight percent to about 60 weight percent, depending on the additive.

The surface layer 14 can have a thickness of about 0.01 millimeters to about 0.5 millimeters, particularly from about 0.01 millimeters to about 0.1 millimeters. Additionally, the surface layer 14 can have surface designs 15 present. For instance, in certain embodiments, the surface design 15 can simulate wood grain. However, other patterns can also be utilized for surface design 15 if desired. Furthermore, the surface layer 12 can be present on one or more surfaces of the composite wood base 12. A surface can refer to any surface of wood base 12 including the top surface, bottom surface, or one or both side surfaces. In certain embodiments, the surface layer 12 can completely wrap the composite wood base 12.

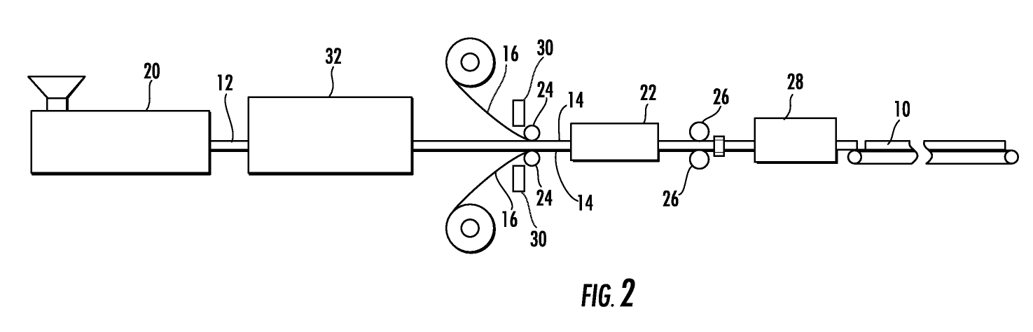

Turning to FIG. 2, methods for manufacturing composite wood products in accordance with the present disclosure will be discussed in more detail. The methods can be carried out in a single manufacturing line so as to form the completed composite wood product 10.

The composite wood base 12 of the present disclosure is formed by extrusion processes. Such extrusion processes are generally well known in the art. It is generally preferred that the materials forming a mass of materials are present in pelletized form. As discussed above, in addition to the fiber material and thermoplastic material, various additives can also be added to the mass of materials prior to extrusion. All of the various materials added to the mass of materials should be present in a size and shape sufficient to form a composite wood product 10 having the characteristics described herein.

A blowing agent or gas can also be added to the mass to reduce the density and weight of the composite wood product 10 by foaming. If a blowing agent is utilized, it is mixed into the mass during blending or at the extruder inlet. In the extruder, the blowing agent is decomposed, disbursing gas, such as nitrogen or CO₂, into the melt. As the extrudate exits the extrusion die, the gas sites experience a pressure drop expanding into small cells or bubbles trapped by the surrounding polymer. This allows the composite wood product 10 described herein to be significantly lighter than conventional composite wood products.

For example, in certain embodiments, the wood base 12 can be formed by introducing materials including respective quantities of a fiber material and thermoplastic material into the inlet of an extruder 20. Preferably, the weigh blender is positioned immediately above the extruder 20, at the extruder inlet, so that the mass of materials is formed immediately prior to entering the extruder 20, thus minimizing or preventing separation of the materials. The materials are then extruded at temperatures and pressures as would be known in the art through the extruder barrel and out the extrusion die to form the composite wood base 12. The composite wood base 12 can be extruded into any suitable shape and/or size depending upon the intended application. After extrusion, the composite wood base 12 can be permitted to cool or can be cooled by any suitable method as would be known in the art, such as a cooling station 32.

After the composite wood base 12 is formed, it is heated at a temperature ranging from about 250° F. to about 375° F., more particularly from about 300° F. to about 400° F., still more particularly from about 315° F. to about 360° F. The composite wood base 12 can be heated in an oven 22 or can be heated by a suitable method as would be known in the art.

A surface material 16 is applied to one or more surfaces of the composite wood base 12, which can include top, bottom, or side surfaces of the composite wood base 12. For instance, as shown in FIG. 2, prior to heating the composite wood base 12, a surface material is applied to the composite wood base to form surface layer 14. The surface material 16 can be applied with several types of coating processes. Suitable coating methods include roll coating wherein the surface material 16 is leveled on the composite wood base by an applicator roll. Preferably, the surface material 16 is present in a rolled sheet and is applied to the composite wood base 12 by one or more rollers 24. The surface material 16 can melt onto the surface of wood base 12 to form the surface layer 14. The surface material can melt onto the surface from the heat provided by oven 22 or can be heated prior to application, such as with a heater 30. A heater 30 can apply heat to surface material 16 just prior to application on the surface of wood base 12. Again, the surface can refer to any surface of wood base 12 including the top surface, bottom surface, or one or both side surfaces. The surface material 16 adheres to the composite wood base to form a surface layer 14 on the composite wood base 12. However, the surface material 16 can be applied by any suitable method as would be known to one of ordinary skill in the art including spraying, brushing, and the like.

Once the surface layer 14 has been formed on the composite wood base 12, the surface layer 14 and/or the composite wood base 12 can be embossed with a suitable embossing device 26 to form a desired surface design in the composite wood product 10. For instance, in certain embodiments, the surface design can simulate wood grain. However, other patterns can also be utilized if desired. In certain embodiments, the embossing device 26 can assist in applying the surface material 16 to the wood base 12. It has been determined that heating the composite wood base 12 provides embossing depth improvement while drawing the thermoplastic material (which appears to have an affinity for the metal surface of an embossing roller) towards the surface which beneficially helps to seal the composite wood base 12. In certain embodiments, the embossing device 26 can be heated to achieve the temperatures desired. The embossing device 26 can emboss one or more of the top, bottom, or side surfaces of the composite wood base 12 and/or surface layer 14, either in combination or alone.

Once the composite wood product 10 has been formed, it can be cut to a desired length by a conventional cutter 28 and packaged for shipment.

It should be understood that variations can be made in the above-described process that are within the scope and spirit of the present disclosure. For instance, the above described cutting operation can be performed immediately after the composite wood base 12 is formed. Similarly, the heating of the composite wood base 12 can occur before the surface layer has been formed on the surface of the composite wood base 12.

It will be appreciated that the inventive method described herein allows for the formation of composite wood products having properties which greatly resemble the properties of natural wood while having much fewer additives than conventional products.

The present disclosure can be better understood with reference to the following examples.

### EXAMPLE

### Base:

48% wood
1% pigment
0.5% UV stabilizer
2% magnesium stearate
48% polypropylene

### Surface Layer:

30% calcium carbonate
3% UV stabilizer
10% pigment
56% polypropylene

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed is:

1. A composite wood product comprising:
a composite wood base, the base comprising about 35 weight percent to about 55 weight percent fiber material and about 35 weight percent to about 55 weight percent thermoplastic resin; and
a surface layer laminated on at least a portion of the base, the surface layer having a thickness of about 0.01 millimeters to about 0.5 millimeters, the surface layer comprising about 0.5 weight percent to about 10 weight percent pigment and about 45 weight percent to about 75 weight percent polyolefin or copolymer thereof.

2. The composite wood product of claim 1, wherein the thermoplastic resin comprises polypropylene.

3. The composite wood product of claim 1, wherein the thermoplastic resin is present in an amount of about 40 weight percent to about 50 weight percent.

4. The composite wood product of claim 1, wherein the fiber material comprises wood fiber, glass fiber, cotton fiber, graphite fiber, or combinations thereof.

5. The composite wood product of claim 1, wherein the fiber material comprises wood fiber.

6. The composite wood product of claim 1, wherein the fiber material is present in an about of about 40 weight percent to about 50 weight percent.

7. The composite wood product of claim 1, wherein the polyolefin comprises polypropylene.

8. The composite wood product of claim 1, wherein the pigment is present in an amount of about 1 weight percent to about 5 weight percent.

9. The composite wood product of claim 1, wherein the surface layer further comprises a filler material, the filler material being present in an amount of about 20 weight percent to about 50 weight percent, the filler material comprising carbonate, talc, silica, or combinations thereof.

10. The composite wood product of claim 1, wherein at least a portion surface layer and base are embossed.

11. The composite wood product of claim 1, wherein the surface layer has a thickness of from about 0.01 millimeters to about 0.1 millimeters.

12. A method for making a composite wood product comprising:
extruding a mass comprising fiber material and thermoplastic resin to form a composite wood base, the base comprising about 35 weight percent to about 55 weight percent fiber material and about 35 weight percent to about 55 weight percent thermoplastic resin; and
laminating a surface material on at least a portion of the base to form a surface layer, the surface layer having a thickness of about 0.01 millimeters to about 0.5 millimeters, the surface layer comprising about 0.5 weight percent to about 10 weight percent pigment and about 45 weight percent to about 75 weight percent polyolefin or copolymer thereof.

13. The method of claim 12, further comprising embossing at least a portion of the surface layer and base.

14. The method of claim 13, wherein the surface layer and base are heated prior to embossing.

15. The method of claim 13, wherein the surface layer and base are heated during embossing.

16. The method of claim 12, wherein the thermoplastic resin comprises polypropylene.

17. The method of claim 12, wherein the fiber material comprises wood fiber.

18. The method of claim 12, wherein the polyolefin comprises polypropylene.

19. The method of claim 12, wherein the surface layer further comprises a filler material, the filler material being present in an amount of about 20 weight percent to about 50 weight percent, the filler material comprising carbonate, talc, silica, or combinations thereof.

20. The method of claim 12, wherein the mass further comprises at least one lubricant and at least one blowing agent.
